(19) United States
(12) Patent Application Publication
(10) Pub. No.: US 2009/0322236 A1
(43) Pub. Date: Dec. 31, 2009

(54) Christmas light string with LED bulb loop and incandescent light bulb loop

(76) Inventors: Chu-Cheng Chang, Hsinchu City (TW); Cheng-Fen Chang, Hsinchu City (TW); Chen-Hsien Chang, Hsinchu City (TW); Chen-Tao Chang, Hsinchu City (TW)

Correspondence Address: BIRCH STEWART KOLASCH & BIRCH, PO BOX 747, FALLS CHURCH, VA, 22040-0747, US

(21) Appl. No.: 12/216,068

(22) Filed: Jun. 27, 2008

(51) Int. Cl. F21S 4/00

(52) U.S. Cl. 315/185 S

(57) ABSTRACT

A Christmas light string includes a plug; a first negative wire together with a first positive wire and the plug forming a circuit; incandescent light bulbs connected together along the first positive and negative wires to form a first loop; a rectifier having a positive input connected to the first incandescent light bulb via a second positive wire and a negative input connected to the last incandescent light bulb via a second negative wire; an end enlargement connected to the positive input of the rectifier via the second positive wire and the negative input of the rectifier via the second negative wire; and LED bulbs forming a second loop between the positive output and the negative output of the rectifier. An optimum illumination is rendered by mixing cold light with warm light. Moreover, mating sockets are adapted to receive the incandescent light bulbs only.

### BACKGROUND OF THE INVENTION

1. Field of Invention

The invention relates to Christmas lighting and more particularly to a Christmas light string with a plurality of LED bulbs arranged in a first loop and a plurality of incandescent light bulbs arranged in a second loop.

2. Description of Related Art

One conventional type of light string for illuminating a Christmas tree comprises a plurality of LED (light-emitting diode) bulbs electrically connected together. LED lamps have the advantages of long useful life, energy-efficient, and capable of resisting shock. However, light rays emitted by the LED bulbs are not warm. Hence, for example, snow may cover the LED bulbs for a relatively long time if the conventional light string is mounted on an outdoor Christmas tree.

The other conventional type of light string for illuminating a Christmas tree comprises a plurality of incandescent light bulbs electrically connected together. Incandescent lamps are able to emit warm light rays to give people a feeling of warmness. However, they are gradually phased out worldwide due to great energy consumption.

Moreover, it is possible of inserting an LED bulb into a socket for incandescent light bulb due to careless. As a result, the LED bulb is burnt because voltage supplied to the incandescent light is AC (alternating current) which is much higher than small DC (direct current) supplied to the LED light. Hence, this is not a safe design.

There have been numerous suggestions in prior patents for Christmas light string. For example, U.S. Pat. No. 6,344,716 discloses a Christmas light string.

Thus, it is desirable to provide a novel Christmas light string with LED bulb loop and incandescent light bulb loop in order to overcome the inadequacies of the prior art.

### SUMMARY OF THE INVENTION

It is therefore one object of the invention to provide a Christmas light string with a plurality of LED bulbs arranged in a first loop and a plurality of incandescent light bulbs arranged in a second loop.

In one aspect of the invention shape of the socket for an LED bulb is different from that of the socket for an incandescent light bulb. It is thus impossible of inserting a DC LED bulb of low voltage into the socket for an AC incandescent light bulb of high voltage. Hence, it is a safe device.

The above and other objects, features and advantages of the invention will become apparent from the following detailed description taken with the accompanying drawings.

### BRIEF DESCRIPTION OF THE DRAWINGS

FIG. 1 is a schematic illustration of a first preferred embodiment of Christmas light string according to the invention;

FIG. 2 schematically shows the circuit formed by the incandescent light bulbs, the LED bulbs, the rectifier, and the positive and negative wires shown in FIG. 1;

FIG. 3 is a side elevation in part section showing an incandescent light bulb to be inserted into a corresponding socket according to the invention;

FIG. 4 is a view similar to FIG. 3 where the incandescent light bulb has been inserted into the corresponding socket;

FIG. 5 is a bottom view of FIG. 4; and

FIG. 6 is a schematic illustration of a second preferred embodiment of Christmas light string according to the invention.

### DETAILED DESCRIPTION OF THE INVENTION

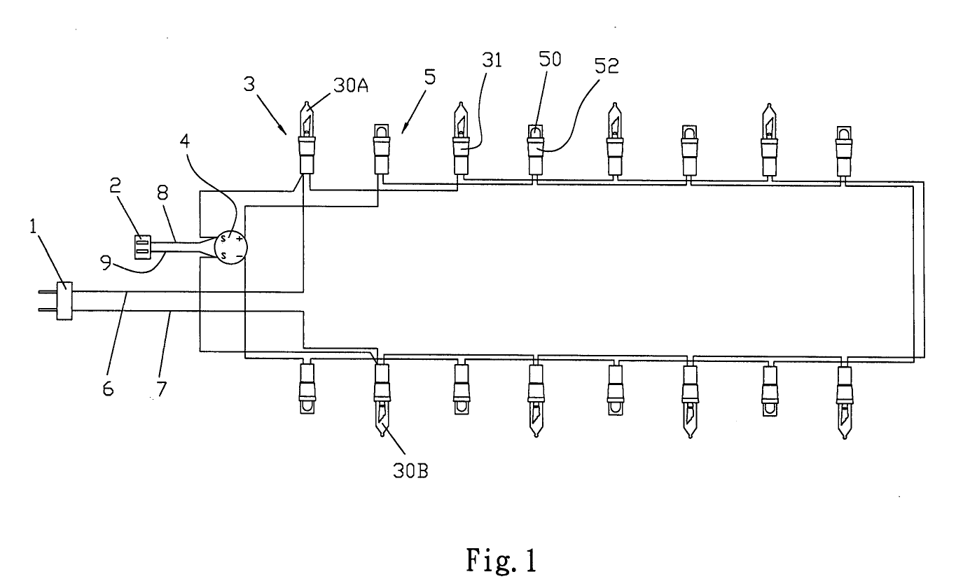

Referring to FIG. 1, a Christmas light string in accordance with a first preferred embodiment of the invention comprises a plug 1, a first positive wire 6 and a first negative wire 7 together with the electrically connected plug 1 forming an electrical circuit, a plurality of incandescent light units 3 electrically connected together along the first positive wire 6 and the first negative wire 7 to form a first loop, a rectifier 4 having a positive input electrically connected to a first one 30A of the incandescent light units 3 via a second positive wire 8 and a negative input electrically connected to a last one 30B of the incandescent light units 3 via a second negative wire 9, an end enlargement 2 electrically connected to the positive input of the rectifier 4 via the second positive wire 8 and the negative input of the rectifier 4 via the second negative wire 9 respectively, and a plurality of LED light units 5 having an LED bulb 50 and a socket 52, the LED light units 5 forming a second loop between the positive output and the negative output of the rectifier 4.

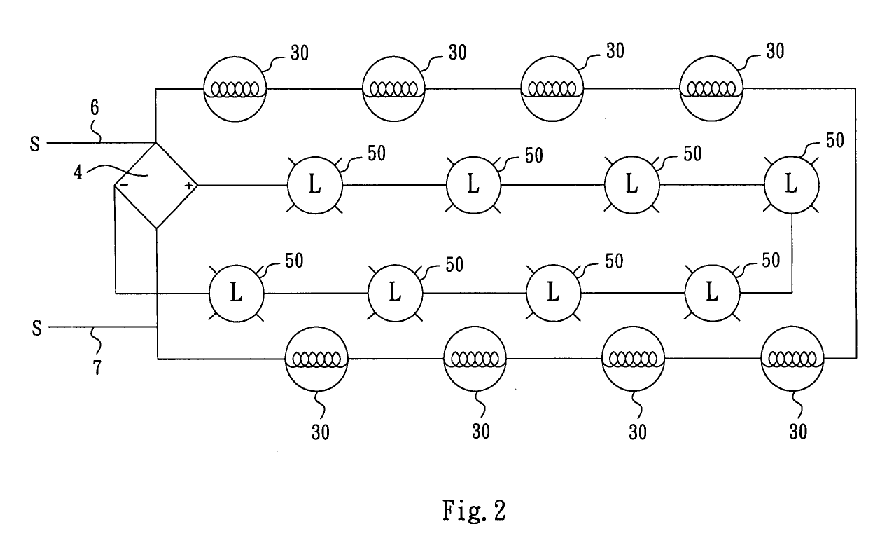

Referring to FIG. 2, a plurality of LED light bulbs 50 are electrically connected together between the positive output and the negative output of the rectifier 4. Also, a plurality of incandescent light bulbs 30 are electrically connected together along the first positive wire 6 and the first negative wire 7.

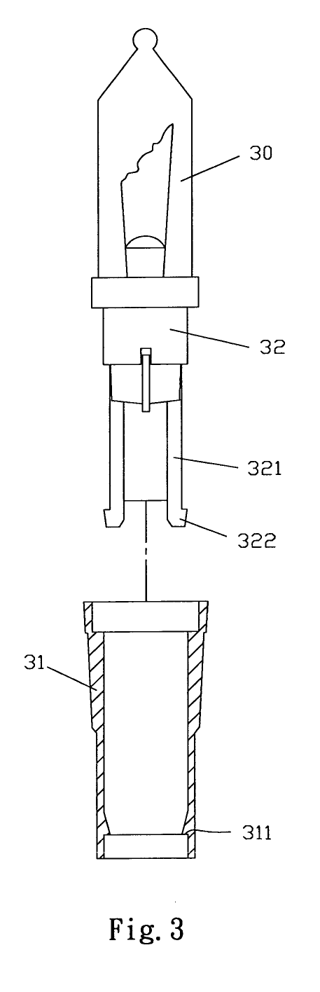

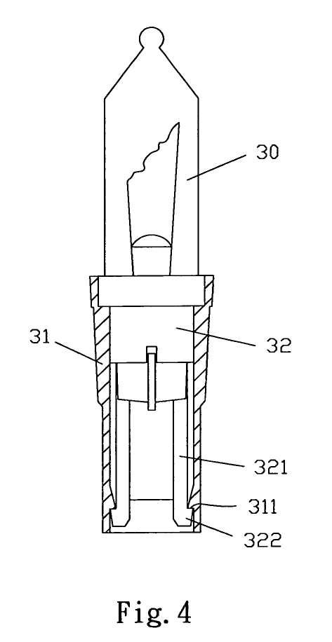

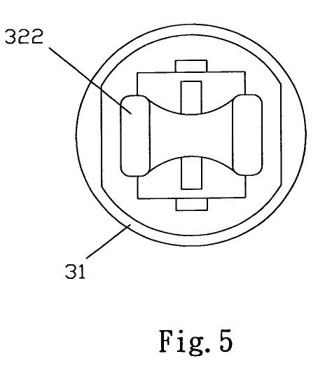

Referring to FIGS. 3, 4 and 5, an incandescent light bulb 30 has an insulating base 32 having two flexible depending arms 321 extending downward, the arm 321 having a hooked end 322. A hollow, cylindrical socket 31 has two opposite inward projecting latched members 311 on its inner surface proximate the open bottom. The incandescent light bulb 30 is adapted to insert into the socket 31 until the hooked ends 322 are secured to the latched members 311 with the base 32 being anchored therein.

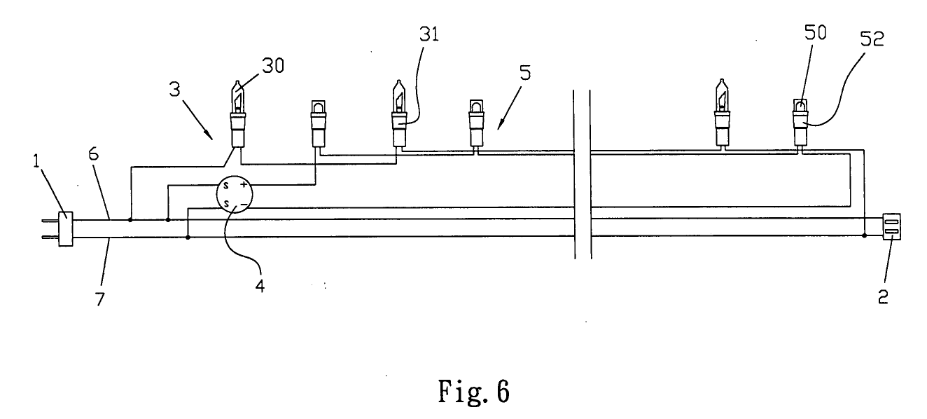

Referring to FIG. 6, a Christmas light string in accordance with a second preferred embodiment of the invention comprises a plug 1, an end enlargement 2, a first positive wire 6 and a first negative wire 7 together with the electrically connected plug 1 and the end enlargement 2 forming an electrical circuit, a rectifier 4 having a positive input electrically connected to the first positive wire 6 and a negative input electrically connected to the first negative wire 7, a plurality of incandescent light units 3 having an incandescent light bulb 30 and a socket 31, the incandescent light units 3 forming a first loop between the first positive wire 6 and the second negative wire 7, and a plurality of LED light units 5 having an LED bulb 50 and a socket 52, the LED light units 5 forming a second loop between the positive output and the negative output of the rectifier 4.

Note that it is impossible of either inserting an incandescent light bulb into an LED lamp socket or inserting an LED bulb into an incandescent lamp socket since they are not matingly shaped. This is a safe design. Otherwise, the DC LED bulb of low voltage can be burnt instantly because AC voltage supplied to the incandescent light is much higher than that supplied to the LED light.

The invention can mix cold light rays emitted by the LED bulbs with warm light rays emitted by the incandescent light bulbs so as to render an optimum illumination to a Christmas tree.

While the invention herein disclosed has been described by means of specific embodiments, numerous modifications and variations could be made thereto by those skilled in the art without departing from the scope and spirit of the invention set forth in the claims.

What is claimed is:

1. A light string comprising:
a plug (1);
a first positive wire (6);
a first negative wire (7) together with the first positive wire (6) and the plug (1) forming an electrical circuit;
a plurality of incandescent light bulbs (3) electrically connected together along the first positive wire (6) and the first negative wire (7) to form a first loop;
a rectifier (4) having a positive input electrically connected to a first one of the incandescent light bulbs (3) via a second positive wire (8) and a negative input electrically connected to a last one of the incandescent light bulbs (3) via a second negative wire (9) respectively;
an end enlargement (2) electrically connected to the positive input of the rectifier (4) via the second positive wire (8) and the negative input of the rectifier (4) via the second negative wire (9) respectively; and
a plurality of LED bulbs (5) forming a second loop between the positive output and the negative output of the rectifier (4).

2. The light string of claim 1, further comprising a plurality of mating sockets (31) adapted to receive the incandescent light bulbs (3).

3. A light string comprising:
a plug (1);
an end enlargement (2);
a first positive wire (6);
a second positive wire (7) together with the first negative wire (7), the plug (1), and the end enlargement (2) forming an electrical circuit;
a rectifier (4) having a positive input electrically connected to the first positive wire (6) and a negative input electrically connected to the first negative wire (7) respectively;
a plurality of incandescent light bulbs (3) forming a first loop between the first positive wire (6) and the second negative wire (7); and
a plurality of LED bulbs (5) forming a second loop between the positive output and the negative output of the rectifier (4).

4. The light string of claim 3, further comprising a plurality of mating sockets (31) adapted to receive the incandescent light bulbs (3).
